(19) United States
(12) Patent Application Publication
(10) Pub. No.: US 2011/0127116 A1
(43) Pub. Date: Jun. 2, 2011

(54) GOVERNOR FOR ELEVATOR

(75) Inventor: Takeshi Niikawa, Tokyo (JP)

(73) Assignee: MITSUBISHI ELECTRIC CORPORATION, Tokyo (JP)

(21) Appl. No.: 13/056,857

(22) PCT Filed: Aug. 28, 2008
(86) PCT No.: PCT/JP2008/065421

§ 371 Date: Jan. 31, 2011

(51) Int. Cl. B66B 5/04; B66B 5/02

(52) U.S. Cl. 187/350

(57) ABSTRACT

Provided is a governor for elevator which permits easy assembling adjustment work due to a simple construction, has a high degree of freedom in the arrangement of fly-weights, an overspeed switch and a rope grasping mechanism and the set mass of the fly-weights, enables the arrangement of the fly-weights and the like, the mass of the fly-weights and the like to be determined specifically for each of the first overspeed detection speed and the second overspeed detection speed, and can detect each of the first overspeed detection speed and the second overspeed detection speed with good accuracy. For this purpose, a governor for elevator which, in order to stop a car of an elevator, detects that the moving speed of the car has reached a first overspeed detection speed and a second overspeed detection speed, includes a first overspeed detection mechanism which detects that the moving speed of the car has reached the first overspeed detection speed, and a second overspeed detection mechanism which is provided separately from the first overspeed detection mechanism and detects that the moving speed of the car has reached the second overspeed detection speed. The first overspeed detection mechanism and the second overspeed detection mechanism are configured to work independently of each other.

### TECHNICAL FIELD

The present invention relates to a governor for elevator.

### BACKGROUND ART

A conventional governor for elevator has been known which is provided, as shown in FIG. 6, with a sheave 8 which is rotatably supported via a sheave shaft 8a, a governor rope 10 which is wound in an endless manner between this sheave 8 and a governor tension sheave rotatably provided in the lower part of a shaft and goes around in synchronization with the car of an elevator, a pair of fly-weights 14 provided on a side surface of the above-described sheave 8 so as to be able to move around, a linking rod 25 which connects these fly-weights 14 in a pair, a balancing spring 15 which urges the above-described fly-weights 14 in a direction adverse to a centrifugal force working on the above-described fly-weights 14 as the above-described sheave 8 rotates, an overspeed switch 19 which stops a driving machine of the elevator by being operated by the above-described fly-weights 14 when the moving speed of the above-described car 5 has reached a first overspeed detection speed, a hook 21 which is arranged in a position where the above-described fly-weights 14 abuts when the moving speed of the above-described car 5 has reached a second overspeed detection speed which is higher than the above-described first overspeed detection speed, and engages with a rope catch 22 during ordinary operation to hang the rope catch 22, and a fixed shoe 23 which sandwiches and brakes the above-described governor rope 10 along with the above-described rope catch 22 which falls down when the engagement with the above-described hook 21 has been released.

Also, a conventional governor for elevator has been known which is provided with a stand, a sheave which is rotatably supported by this stand, on which a governor rope is wound, and which rotates according to the ascending and descending speed of a car, a pair of fly-weights which is attached to this sheave so as to be able to move around and rotates by a centrifugal force due to the rotation of the above-described sheave, a first balancing spring which constantly urges the above-described fly-weights in a direction adverse to the above-described centrifugal force, and is used in setting and detecting a first overspeed detection speed of the above-described car, a second balancing spring which urges the above-described fly-weights in a direction adverse to the above-described centrifugal force only when the speed of the above-described car is not less than the above-described first overspeed detection speed, and is used in setting and detecting a second overspeed detection speed which is higher than the first overspeed detection speed of the above-described car, a car stopping switch (an overspeed switch) which stops a driving machine of the above-described car by being operated by the above-described fly-weights when the speed of the above-described car has reached the above-described first overspeed detection speed, and a rope clamping mechanism which brakes the above-described governor rope by being operated by the above-described fly-weights when the speed of the above-described car has reached the above-described second overspeed detection speed (refer to Patent Document 1, for example).
Patent Document 1: Japanese Patent Laid-Open No. 08-119555

### DISCLOSURE OF THE INVENTION

### Problems to be Solved by the Invention

However, in the conventional governor for elevator described in Patent Document 1, the second balancing spring urges the fly-weights in a direction adverse to the centrifugal force only when the speed of the car is not less than the above-described first overspeed detection speed, and hence, concretely, the second balancing spring is passed onto a rod to both end portions of which the fly-weights are connected so as to be able to move around, and a spring force adjusting nut is screwed onto the side of one end of the second balancing spring of this rod, and on the side of the other end of the second balancing spring, a patch is passed and a collar abutting against this patch is then fixed to the rod, whereby a prescribed gap is formed between this patch and a stop plate fixed to a side surface portion of the sheave.

A prescribed gap formed between this patch and the stop plate is adjusted so that the patch and the stop plate abut against each other when the speed of the car is not less than the first overspeed detection speed and not more than the second overspeed detection speed; however, this is influenced by the amount of displacement of the fly-weights when the speed of the car is not less than the first overspeed detection speed and not more than the second overspeed detection speed, i.e., by the degree of adjustment of the spring force of the first balancing spring.

Therefore, in the assembly adjustment of this governor, elements such as the amount of displacement of the fly-weights related to the operation of the overspeed switch and the rope grasping mechanism, the spring force of each of the first balancing spring and the second balancing spring, and the gap between the patch and the stop plate in the rod onto which the second balancing spring is passed, are correlated to each other and the number of adjustment points increases, thereby posing the problem that the assembly adjustment work becomes complicated and difficult, requiring a lot of trouble, and the problem that the construction of the governor becomes complex.

In both the conventional governor for elevator shown in FIG. 6 and the conventional governor for elevator described in Patent Document 1, the configuration is such that two different overspeed detection speeds, which are the first overspeed detection speed and the second overspeed detection speed, are detected by the amount of displacement of a pair of fly-weights constituting one link system and, therefore, this poses the problem that the degree of freedom is low in the amount of displacement of the fly-weights related to the operation of the overspeed switch and the rope grasping mechanism, i.e., the arrangement of the fly-weights, overspeed switch and rope grasping mechanism and the set mass of the fly-weights, and also the problem that it is impossible to determine the arrangement of the fly-weights, overspeed switch and rope grasping mechanism, the mass of the fly-weights and the specifications for the balancing springs specifically for each of the first overspeed detection speed and the second overspeed detection speed.

The present invention has been made to solve the problems described above, and provides a governor for elevator which permits easy assembling adjustment work due to a simple construction, has a high degree of freedom in the arrangement of fly-weights, an overspeed switch and a rope grasping mechanism and the set mass of the fly-weights, enables the arrangement of the fly-weights, overspeed switch and rope grasping mechanism, the mass of the fly-weights and the specifications for balancing springs to be determined specifically for each of the first overspeed detection speed and the second overspeed detection speed, and can detect each of the first overspeed detection speed and the second overspeed detection speed with good accuracy.

### Means for Solving the Problems

The present invention relates to a governor for elevator which, in order to stop a car of an elevator, detects that the moving speed of the car has reached a first overspeed detection speed higher than a rated speed and a second overspeed detection speed higher than the first overspeed detection speed, there are provided a first overspeed detection mechanism which detects that the moving speed of the car has reached the first overspeed detection speed, and a second overspeed detection mechanism which is provided separately from the first overspeed detection mechanism and detects that the moving speed of the car has reached the second overspeed detection speed, and the first overspeed detection mechanism and the second overspeed detection mechanism each work independently of each other.

### Advantages of the Invention

The present invention relates to a governor for elevator. In a governor which, in order to stop a car of an elevator, detects that the moving speed of the car has reached a first overspeed detection speed higher than a rated speed and a second overspeed detection speed higher than the first overspeed detection speed, there are provided a first overspeed detection mechanism which detects that the moving speed of the car has reached the first overspeed detection speed, and a second overspeed detection mechanism which is provided separately from the first overspeed detection mechanism and detects that the moving speed of the car has reached the second overspeed detection speed, and the first overspeed detection mechanism and the second overspeed detection mechanism each work independently of each other, whereby the present invention provides the advantages that it is possible to perform assembly adjustment work easily due to a simple construction, that a high degree of freedom is ensured in the arrangement of fly-weights, an overspeed switch and a rope grasping mechanism and the set mass of the fly-weights, that it is possible to determine the arrangement of the fly-weights, overspeed switch and rope grasping mechanism, the mass of the fly-weights and the specifications for balancing springs specifically for each of the first overspeed detection speed and the second overspeed detection speed, and that it is possible to detect each of the first overspeed detection speed and the second overspeed detection speed with good accuracy.

### BRIEF DESCRIPTION OF THE DRAWINGS

FIG. 1 is a front view of a governor for elevator related to Embodiment 1 of the present invention.

FIG. 2 is a schematic block diagram showing an outline of the general construction of an elevator related to Embodiment 1 of the present invention.

FIG. 3 is a front view of a governor for elevator related to Embodiment 2 of the present invention.

FIG. 4 is a front view of a governor for elevator related to Embodiment 3 of the present invention.

FIG. 5 is a sectional view of a main part of a governor for elevator related to Embodiment 4 of the present invention.

FIG. 6 is a front view of a conventional governor for elevator.

### DESCRIPTION OF SYMBOLS

1 shaft
2 machine room
3 driving machine
4 main rope
5 car
5a arm portion
6 counterweight
7 governor
8 sheave
8a sheave shaft
9 governor tension sheave
10 governor rope
11a first bearing fixing portion
11b second bearing fixing portion
12a first linear motion bearing
12b second linear motion bearing
13a first rod
13b second rod
14 fly-weight
14a first fly-weight
14b second fly-weight
15 balancing spring
15a first balancing spring
15b second balancing spring
16a first patch
16b second patch
17a first spring force adjusting nut
17b second spring force adjusting nut
18a first overspeed detection mechanism
18b second overspeed detection mechanism
19 overspeed switch
20 actuating cam
21 hook
21a pin
22 rope catch
23 fixed shoe
24 rotary body
25 linking rod

### BEST MODE FOR CARRYING OUT THE INVENTION

The present invention will be described with reference to the accompanying drawings. In each of the drawings, like numerals refer to like or similar parts and overlaps of description of these parts are appropriately simplified or omitted.

### Embodiment 1

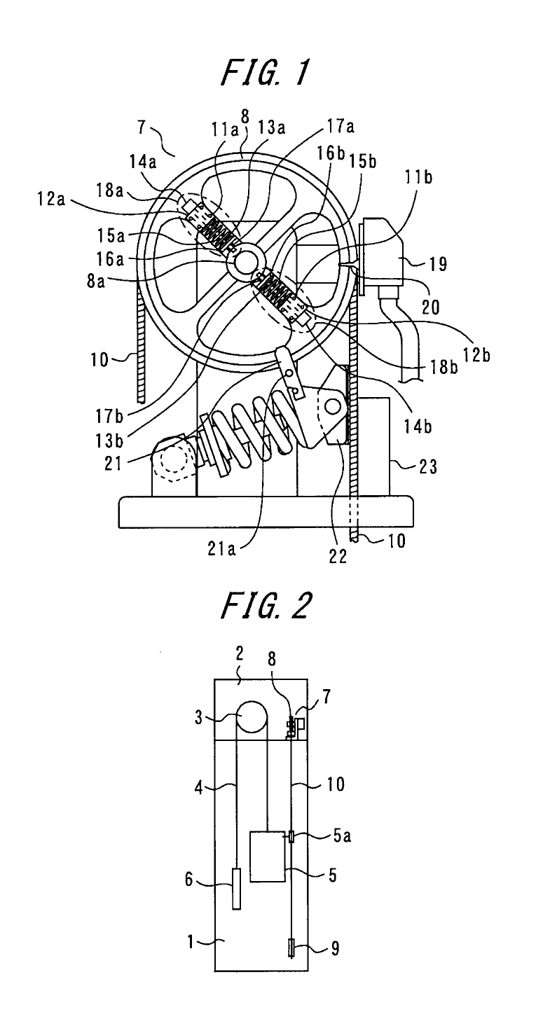

FIGS. 1 and 2 relate to Embodiment 1 of the present invention. FIG. 1 shows a front view of a governor for elevator and FIG. 2 is a schematic block diagram showing an outline of the general construction of an elevator.

In the figures, reference numeral 1 denotes an elevator shaft and a machine room 2 is provided at a top end of this shaft 1. A driving machine 3 which motor-drives the elevator is installed in this machine room 2, and a main rope 4 is wound on a driving sheave of this driving machine 3. And a car 5 which is arranged within the above-described shaft 1 so as to ascend and descend freely is connected to an end of this main rope 4, and a counterweight 6 arranged within the above-described shaft 1 so as to ascend and descent freely is connected to the other end of the above-described main rope 4 in order to compensate for the weight of the above-described car 5.

Within the above-described machine room 2, a governor 7 is installed adjacent to the above-described driving machine 3, and a sheave 8 is rotatably provided in this governor 7. This sheave 8 is rotatably supported by a sheave shaft 8a provided at the center of the sheave 8.

Between the above-described sheave 8 and a governor tension sheave 9 rotatably provided in the lower part of the above-described shaft 1, a governor rope 10 is wound in an endless manner. This governor rope 10 is latched onto the above-described car 5 via an arm portion 5a, and when the above-described car 5 moves, the above-described governor rope 10 goes around and the above-described sheave 8 rotates. The rotation speed of the above-described sheave 8 is determined according to the moving speed of the above-described car 5. That is, the higher the moving speed of the above-described car 5, higher the rotation speed of the above-described sheave 8, and the lower the moving speed of the above-described car 5, the lower the rotation speed of the above-described sheave 8.

A first bearing fixing portion 11a and a second bearing fixing portion 11b are provided on a side surface of a spoke portion provided radially from a shaft portion of the above-described sheave 8, and the first bearing fixing portion 11a and the second bearing fixing portion 11b are arranged symmetrically about a rotational center of the above-described sheave 8 along a straight line passing through this rotational center, i.e., along the diameter.

A first linear motion bearing 12a is fixed to the above-described first bearing fixing portion 11a, and a first rod 13a is attached so as to be able to slide in the radial direction of the above-described sheave 8 by use of this first linear motion bearing 12a.

A first fly-weight 14a is attached to an end portion on the radial outside of the above-described first linear motion bearing 12a of the above-described first rod 13a, and on the radial center side of the above-described first linear motion bearing 12a of the above-described first rod 13a, after the passing of a first balancing spring 15a and a first patch 16a in this order, a first spring force adjusting nut 17a is screwed onto a radial center-side end portion of the above-described first rod 13a.

A radial outer end portion of the above-described first balancing spring 15a abuts against the first linear motion bearing 12a, a radial center-side end portion of the above-described first balancing spring 15a abuts against the first patch 16a inserted between the above-described first balancing spring 15a and the above-described first spring force adjusting nut 17a, and the above-described first balancing spring 15a urges the above-described first fly-weight 14a in the direction in which the first fly-weight 14a is moved in the center direction. And in an initial position, a radial center-side end portion of the above-described first fly-weight 14a is pressurized by the above-described first balancing spring 15a so that the radial center-side end portion of the above-described first fly-weight 14a comes into abutment against a radial outer end portion of the above-described first linear motion bearing 12a.

The second linear motion bearing 12b is fixed to the above-described second bearing fixing portion 11b, and a second rod 13b is attached so as to be able to slide in the radial direction of the above-described sheave 8 by use of this second linear motion bearing 12b.

A second fly-weight 14b is attached to an end portion on the radial outer side of the above-described second linear motion bearing 12b of the above-described second rod 13b, and on the radial central side of the above-described second linear motion bearing 12b of the above-described second rod 13b, after the passing of a second balancing spring 15b and a second patch 16b in this order, a second spring force adjusting nut 17b is screwed onto a radial center-side end portion of the above-described second rod 13b.

A radial outer end portion of the above-described second balancing spring 15b abuts against the second linear motion bearing 12b, a radial center-side end portion of the above-described second balancing spring 15b abuts against the second patch 16b inserted between the above-described second balancing spring 15b and the above-described second spring force adjusting nut 17b, and the above-described second balancing spring 15b urges the above-described second fly-weight 14b in the direction in which the second fly-weight 14h is moved in the center direction. And in an initial position, a radial center-side end portion of the above-described second fly-weight 14b is pressurized by the above-described second balancing spring 15b so that the radial center-side end portion of the above-described second fly-weight 14b comes into abutment against a radial outer end portion of the above-described second linear motion bearing 12b.

Incidentally, as the above-described first linear motion bearing 12a and the above-described second linear motion bearing 12b, sliding bearings using sliding friction may be used or rolling bearings using the rolling friction of balls and rollers may be used.

When the above-described sheave 8 rotates, the above-described first fly-weight 14a and the above-described second fly-weight 14b thus attached to the above-described first bearing fixing portion 11a and the above-described second bearing fixing portion 11b of the above-described sheave 8 receives a centrifugal force responsive to the rotation speed in the direction from the above-described sheave shaft 8a, which is the rotational center, to the outer side. Because the arrangement is performed so that the rotational center of the above-described sheave 8 is positioned on an extended line of the movement trajectory of the above-described first fly-weight 14a and the above-described second fly-weight 14b, it can be otherwise put that the moving direction of the above-described first fly-weight 14a and the above-described second fly-weight 14b are on a line of action of the above-described centrifugal force.

For example, for the above-described first fly-weight 14a, if the above-described centrifugal force applied by the rotation of the above-described sheave 8 exceeds the elastic force given by the above-described first balancing spring 15a, then the above-described first fly-weight 14a moves to the radial outer side.

When the above-described first fly-weight 14a moves to the radial outer side, the above-described first balancing spring 15a is compressed according to this amount of movement and the above-described elastic force which urges the above-described first fly-weight 14a increases. The movement of the above-described first fly-weight 14a to the radial outer side stops at a point where a balance is reached between the above-described centrifugal force and the above-described elastic force. Therefore, the amount of movement of the above-described first fly-weight 14a is determined by the above-described centrifugal force, i.e., the rotation speed of the above-described sheave 8 and the above-described elastic force of the above-described first balancing spring 15a.

Because as described above the rotation speed of the above-described sheave 8 corresponds to the moving speed of the above-described car 5, the moving position of the above-described first fly-weight 14a at a certain moving speed of the above-scribed car 5 is determined by the above-described elastic force of the above-described first balancing spring 15a and this elastic force can be appropriately adjusted by changing the screwing position of the above-described first spring force adjusting nut 17a. Therefore, it is possible to adjust the moving position of the above-described first fly-weight 14a at a certain moving speed of the above-described car 5 by adjusting the above-described elastic force of the above-described first balancing spring 15a by use of the above-described first spring force adjusting nut 17a.

Conversely, when the moving speed of the above-described car 5 has been changed from a certain moving speed to a different moving speed by adjusting the above-described elastic force of the above-described first balancing spring 15a by use of the above-described first spring force adjusting nut 17a, it is also possible to make adjustment so that before and after the change of the moving speed the moving position of the above-described first fly-weight 14a maintains the same moving position.

This situation applies also to the above-described second fly-weight 14b.

In the position where the above-described first fly-weight 14a abuts in a moving position when the moving speed of the above-described car 5 has reached the above-described first overspeed detection speed (for example, a speed on the order of 1.3 times a rated speed), an actuating cam 20 of an overspeed switch 19 is arranged which stops the power supply to the above-described driving machine 3 and a brake which is not shown by actuating the overspeed switch 19.

In the position where the above-described second fly-weight 14b abuts in a moving position when the moving speed of the above-described car 5 has reached the above-described second overspeed detection speed higher than the above-described first overspeed detection speed (for example, a speed on the order of 1.4 times a rated speed), an end of a hook 21 attached so as to be able to move around by use of a pin 21a is arranged.

During ordinary operation, the other end of this hook 21 engages with a rope catch 22 so as to hang the rope catch 22, and when the above-described second fly-weight 14b abuts against an end of the above-described hook 21 and the above-described hook 21 moves around, the engagement between the other end of the above-described hook 21 and the above-described rope catch 22 becomes released and the above-described rope catch 22 falls down by gravitation, with the result that the above-described governor rope 10 becomes sandwiched between the above-described rope catch 22 which has fallen down and a fixed shoe 23. When the above-described governor rope 10 is braked in this manner, an emergency stop device provided in the above-described car 5, which is not shown, works and the above-described car 5 stops.

Thus, the above-described first linear motion bearing 12a attached to the above-described first bearing fixing portion 11a, the above-described first rod 13a, the above-described first fly-weight 14a, the above-described first balancing spring 15a, the above-described first patch 16a and the above-described first spring force adjusting nut 17a constitute a first overspeed detection mechanism 18a which detects the above-described first overspeed detection speed, and the above-described second linear motion bearing 12b attached to the above-described second bearing fixing portion 11b, the above-described second rod 13b, the above-described second fly-weight 14b, the above-described second balancing spring 15b, the above-described second patch 16b and the above-described second spring force adjusting nut 17b constitute a second overspeed detection mechanism 18b which detects the above-described second overspeed detection speed.

When the elevator is operated and the above-described car 5 moves, the above-described sheave 8 of the above-described governor 7 rotates at a rotation speed responsive to the moving speed of the above-described car 5 via the above-described governor rope 10, and the above-described first fly-weight 14a and the above-described second fly-weight 14b also rotate as a result of the rotation of the above-described sheave 8 and, therefore, a centrifugal force acts on these fly-weights.

However, because the above-described first fly-weight 14a and the above-described second fly-weight 14b are pressurized by the above-described first balancing spring 15a and the above-described second balancing spring 15b, respectively, in the direction toward the rotational center of the above-described sheave 8, i.e., in a direction adverse to the above-described centrifugal force and the above-described pressure given by the above-described first balancing spring 15a and the above-described second balancing spring 15b exceeds the above-described centrifugal force until the moving speed of the above-described car 5 exceeds, for example, a rated speed, the above-described first fly-weight 14a and the above-described second fly-weight 14b will not start to move to the radial outer side of the above-described sheave 8.

When the moving speed of the above-described car 5 increases and exceeds a rated speed, the above-described centrifugal force exceeds the above-described pressure given by the above-described first balancing spring 15a and the above-described second balancing spring 15b and the above-described first fly-weight 14a and the above-described second fly-weight 14b start to move to the radial outer side of the above-described sheave 8.

When the moving speed of the above-described car 5 increases further and has reached the above-described first overspeed detection speed, the above-described first fly-weight 14a moves to the position where the above-described first fly-weight 14a abuts against the above-described actuating cam 20 of the above-described overspeed switch 19, and the abutment of this first fly-weight 14a against the above-described actuating cam 20 enables the above-described overspeed switch 19 to start to work, with the result that the power supply to the above-described driving machine 3 and the above-described brake is stopped and a trial is made to perform an emergency stop of the above-described car 5.

In the stage when the moving speed of the above-described car 5 has reached the above-described first overspeed detection speed, the above-described second fly-weight 14b has not yet moved to the position where the above-described second fly-weight 14b abuts against an end of the above-described hook 21. However, in the case where the above-described car 5 does not stop even by the operation of the above-described overspeed switch 19 (for example, a probable case where the above-described main rope 4 is broken), when the moving speed of the above-described car 5 has reached the above-described second overspeed detection speed, the above-described second fly-weight 14b moves to the position where the above-described second fly-weight 14b abuts against an end of the above-described hook 21.

Due to the abutment of this second fly-weight 14b against an end of the above-described hook 21, the above-described hook 21 moves around, the engagement between the other end of the above-described hook 21 and the above-described rope catch 22 becomes released and the above-described rope catch 22 falls down by gravitation, with the result that the above-described governor rope 10 becomes sandwiched between the above-described rope catch 22 which has fallen down and a fixed shoe 23. When the above-described governor rope 10 is braked in a sandwiched manner like this, the above-described emergency stop device provided in the above-described car 5 works in synchronization with this braking and the above-described car 5 stops in an emergency.

The governor for elevator configured as described above is provided with the first overspeed detection mechanism which detects that the moving speed of the car has reached a first overspeed detection speed, and the second overspeed detection mechanism which detects that the moving speed of the car has reached a second overspeed detection speed. Because the first overspeed detection mechanism and the second overspeed detection mechanism are provided separately from each other and operate independently of each other, it is possible to determine the arrangement of the fly-weights, overspeed switch and rope grasping mechanism, the mass of the fly-weights and the specifications for balancing springs specifically for each of the first overspeed detection speed and the second overspeed detection speed, and it is possible to detect each of the first overspeed detection speed and the second overspeed detection speed with good accuracy.

By providing the first overspeed detection mechanism and the second overspeed detection mechanism separately from each other, in each of the overspeed detection mechanisms it is possible to adopt a configuration in which the fly-weights are attached so as to be able to slide linearly by use of the linear motion bearings. Therefore, it is possible to perform assembly adjustment work easily due to a simple construction, and a high degree of freedom is ensured in the arrangement of the fly-weights, the overspeed switch and the rope grasping mechanism and the set mass of the fly-weights.

### Embodiment 2

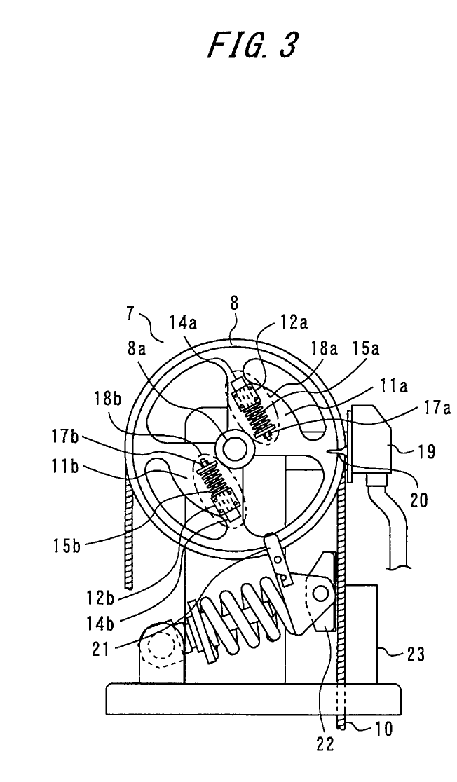

FIG. 3 relates to Embodiment 2 of the present invention and is a front view of a governor for elevator.

In Embodiment 1 described above, the arrangement is performed so that the rotational center of the sheave is positioned on an extended line of the movement trajectory of the first fly-weight and the second fly-weight, in other words, so that the moving direction of the first fly-weight and the second fly-weight is positioned on the diameter of the sheave. In Embodiment 2 which will be described here, the arrangement is performed so that the rotational center of the sheave is not positioned on an extended line of the movement trajectory of the first fly-weight and the second fly-weight, in other words, so that the moving direction of the first fly-weight and the second fly-weight is not positioned on the diameter of the sheave.

That is, in the above-described spoke portion of the above-described sheave 8, a first bearing fixing portion 11a whose central angle has a substantially right-angled fan-like shape is formed, and a first linear motion bearing 12a is fixed to this first bearing fixing portion 11a. Like Embodiment 1 described above, a first rod 13a, a first fly-weight 14a, a first balancing spring 15a, a first patch 16a, and a first spring force adjusting nut 17a are provided, and these constitute a first overspeed detection mechanism 18a which detects the above-described first overspeed detection speed.

As described above, the above-described first overspeed detection mechanism 18a is arranged so that the rotational center of the above-described sheave 8 is not positioned on an extended line of the movement trajectory of the above-described first fly-weight 14a and so that the moving direction of the above-described first fly-weight 14a does not become parallel to the tangential direction of the above-described sheave 8.

In the position of the above-described spoke portion of the above-described sheave 8 where a second bearing fixing portion 11b is point-symmetrical relation to the above-described first bearing fixing portion 11a about the rotational center of the above-described sheave 8 in the spoke portion of the above-described sheave 8, a second bearing fixing portion 11a whose central angle has a substantially right-angled fan-like shape is formed, and in the same manner as with the above-described first overspeed detection mechanism 18a, i.e., in the same manner as with Embodiment 1 described above, a second linear motion bearing 12b, a second rod 13b, a second fly-weight 14b, a second balancing spring 15b, a second patch 16b, and a second spring force adjusting nut 17b are provided in this second bearing fixing portion 11b, and these constitute a second overspeed detection mechanism 18b which detects the above-described second overspeed detection speed.

The moving direction of the above-described second fly-weight 14b is set to be parallel to the moving direction of the above-described first fly-weight 14a and to be reverse thereto, that is, the above-described second overspeed detection mechanism 18b is arranged so that the rotational center of the above-described sheave 8 is not positioned on an extended line of the movement trajectory of the above-described second fly-weight 14b.

Other constitutional features are the same as in Embodiment 1 described above.

In the above-described governor 7 thus configured, think about a locus generated by a point positioned on an outermost side for the radial direction of the above-described sheave 8 of the above-described first fly-weight 14a and the above-described second fly-weight 14b in the case where the above-described sheave 8 is rotating at a constant speed, then it is apparent that concentric circles around the rotational center of the above-described sheave 8 are formed. This is quite the same as with Embodiment 1 described above and there is no difference in the least. Therefore, the operation of the above-described governor 7 thus configured can be performed in the same manner as in Embodiment 1 described above, by appropriately performing the adjustment of the arrangement and position of the above-described actuating cam 20 and the above-described hook 21 and the adjustment of the elastic force of the above-described first balancing spring 15a and the above-described second balancing spring 15b by use of the above-described first spring force adjusting nut 17a and the above-described second spring force adjusting nut 17b.

In the governor for elevator configured as described above, it is possible to obtain the same advantages as in Embodiment 1 and in addition, the flexibility related to the arrangement of the fly-weights, the overspeed switch and the rope grasping mechanism increases and, for example, it becomes possible to apply the present invention to a governor having a small-diameter sheave.

### Embodiment 3

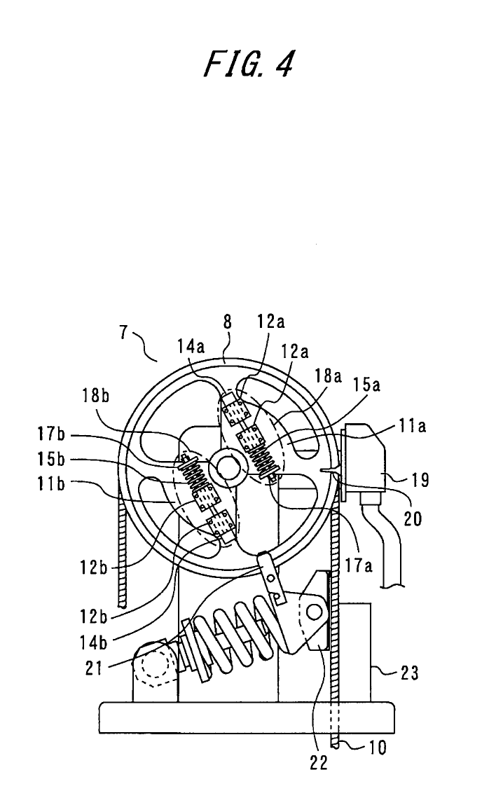

FIG. 4 relates to Embodiment 3 of the present invention and is a front view of a governor for elevator.

Embodiment 3 which will be described here is such that in Embodiment 2 described above, the above-described first linear motion bearing 12a and the above-described second linear motion bearing 12b are each provided in multiple numbers.

That is, as shown in FIG. 4, a plurality of (two, in this case) above-described linear motion bearings 12a are fixed to the above-described first bearing fixing portion 11a. As a result of this, the length of the above-described first rod 13a is larger than in Embodiment 3. Similarly, a plurality of (two, in this case) above-described second linear motion bearings 12b are fixed to the above-described second bearing fixing portion 11b and as a result of this, the length of the above-described second rod 13b is larger than in Embodiment 3.

Other constitutional features and the operation of the governor are the same as in Embodiment 2 described above.

In Embodiment 2, the arrangement is performed so that the moving direction of the first fly-weight and the second fly-weight is not positioned on the diameter of the sheave and, therefore, the moving direction of these fly-weights becomes a direction different from the direction of action of a centrifugal force acting on these fly-weights due to rotation. For this reason, a moment is generated which causes these fly-weights to rotate around the linear motion bearings which slidably support these fly-weights due to the centrifugal force acting on these fly-weights, and a load for resisting this moment is applied to the linear motion bearings.

In contrast to this, in the governor for elevator of Embodiment 3 which is configured as described above, it is possible to cause the fly-weights to perform sliding displacement more smoothly by dispersing the load for resisting the moment by use of a plurality of linear motion bearings while ensuring the same advantages as in Embodiment 2. Therefore, it is possible to further improve the accuracy with which the overspeed of a car is detected.

### Embodiment 4

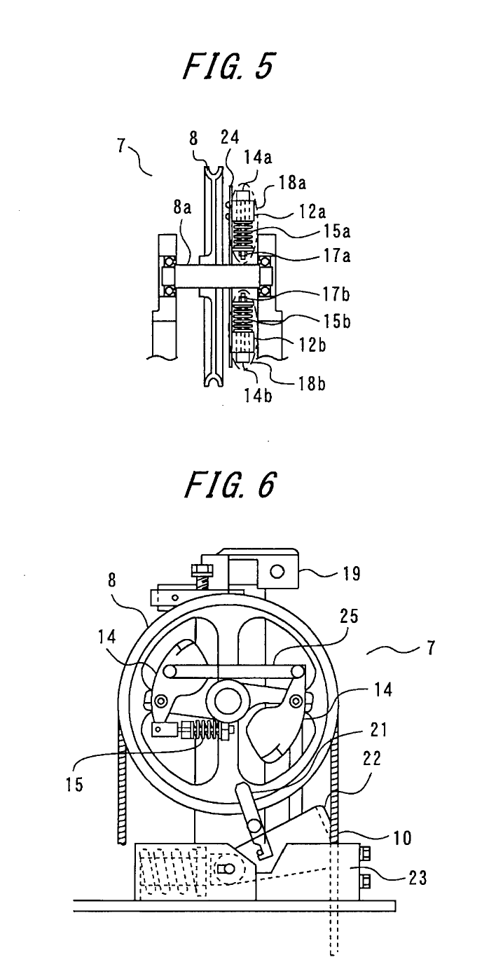

FIG. 5 relates to Embodiment 4 of the present invention and is a sectional view of a main part of a governor for elevator.

In Embodiment 1, Embodiment 2 and Embodiment 3 described above, the first overspeed detection mechanism and the second overspeed detection mechanism are attached directly to a side surface of the spoke portion of the sheave. In Embodiment 4 which will be described here, to a sheave shaft which is fixed at the center of a sheave so as to rotate as a unit with the sheave, there is fixed a rotary body, which rotates with the sheave and the sheave shaft and is a body separate from the sheave, and the first overspeed detection mechanism and the second overspeed detection mechanism are attached to this rotary body.

That is, the above-described sheave shaft 8a which rotates as a unit with the above-described sheave 8 is fixed at the center of the above-described sheave 8, and a disc-like or flat-plate-like rotary body 24 which is arranged to be parallel to the above-described sheave 8 at the side of the above-described sheave 8 is fixed to the above-described sheave shaft 8a. A first bearing fixing portion 11a and a second bearing fixing portion 11b are provided in this rotary body 24, and the above-described first overspeed detection mechanism 18a and the above-described second overspeed detection mechanism 18b are attached to these bearing fixing portions in the same manner as with Embodiment 1, Embodiment 2 or Embodiment 3 described above.

Thus, other constitutional features except that the first overspeed detection mechanism and the second overspeed detection mechanism are attached to the rotary body which rotates with the sheave and is a body separate from the sheave, and the operation of the governor are the same as in Embodiment 1, Embodiment 2 and Embodiment 3.

In the governor for elevator which is configured as described above, it is possible to provide the same advantages as in Embodiment 1, Embodiment 2 and Embodiment 3. In addition, the degree of freedom of arrangement becomes high because the first overspeed detection mechanism and the second overspeed detection mechanism can be appropriately arranged on the rotary body, and it becomes possible to apply the present invention to governors of various configurations and shapes.

### INDUSTRIAL APPLICABILITY

The present invention can be applied to a governor which, in order to stop a car of an elevator, can detect that the moving speed of the car has reached a first overspeed detection speed higher than a rated speed and a second overspeed detection speed higher than the first overspeed detection speed.

1-7. (canceled)

8. A governor for an elevator which, in order to stop a car of an elevator, detects that the moving speed of the car has reached a first overspeed detection speed higher than a rated speed and a second overspeed detection speed higher than the first overspeed detection speed, comprising:
a first overspeed detection mechanism which mechanically detects that the moving speed of the car has reached the first overspeed detection speed; and
a second overspeed detection mechanism which is provided separately from the first overspeed detection mechanism and mechanically detects that the moving speed of the car has reached the second overspeed detection speed,
wherein the first overspeed detection mechanism and the second overspeed detection mechanism each work independently of each other.

9. The governor for an elevator according to claim 8, further comprising a sheave which rotates according to the moving speed of the car,
wherein the first overspeed detection mechanism includes a first fly-weight which rotates with the sheave and moves to a radial outer side of the rotation by receiving a centrifugal force working due to the rotation, and a first balancing spring which urges the first fly-weight in a direction opposite to the direction in which the first fly-weight moves by receiving the centrifugal force and is used in setting and detecting the first overspeed detection speed of the car, and
wherein the second overspeed detection mechanism includes a second fly-weight which rotates with the sheave and moves to a radial outer side of the rotation by receiving a centrifugal force working due to the rotation, and a second balancing spring which urges the second fly-weight in a direction opposite to the direction in which the second fly-weight moves by receiving the centrifugal force and is used in setting and detecting the second overspeed detection speed of the car

10. The governor for an elevator according to claim 9,
wherein the first fly-weight and the second fly-weight are configured to slide linearly, and
wherein the first overspeed detection mechanism and the second overspeed detection mechanism are provided to be point-symmetrical about a center of the rotation of the first fly-weight and of the second fly-weight and so that the center is positioned on an extended line in the direction in which the first fly-weight and the second fly-weight can slide.

11. The governor for an elevator according to claim 9,
wherein the first fly-weight and the second fly-weight are configured to slide linearly, and
wherein the first overspeed detection mechanism and the second overspeed detection mechanism are provided to be point-symmetrical about a center of the rotation of the first fly-weight and of the second fly-weight and so that the center is not positioned on an extended line in the direction in which the first fly-weight and the second fly-weight can slide.

12. The governor for an elevator according to claim 11,
wherein the first overspeed detection mechanism includes a plurality of first linear motion bearings to which the first fly-weight is slidably attached, and
wherein the second overspeed detection mechanism includes a plurality of second linear motion bearings to which the second fly-weight is slidably attached.

13. The governor for an elevator according to claim 9, wherein the first overspeed detection mechanism and the second overspeed detection mechanism are attached to a side surface of the sheave.

14. The governor for an elevator according to claim 10, wherein the first overspeed detection mechanism and the second overspeed detection mechanism are attached to a side surface of the sheave.

15. The governor for an elevator according to claim 11, wherein the first overspeed detection mechanism and the second overspeed detection mechanism are attached to a side surface of the sheave.

16. The governor for an elevator according to claim 12, wherein the first overspeed detection mechanism and the second overspeed detection mechanism are attached to a side surface of the sheave.

17. The governor for an elevator according to claim 9, further comprising a rotary body which is provided separately from the sheave and rotates with the sheave,
wherein the first overspeed detection mechanism and the second overspeed detection mechanism are attached to the rotary body.

18. The governor for an elevator according to claim 10, further comprising a rotary body which is provided separately from the sheave and rotates with the sheave,
wherein the first overspeed detection mechanism and the second overspeed detection mechanism are attached to the rotary body.

19. The governor for an elevator according to claim 11, further comprising a rotary body which is provided separately from the sheave and rotates with the sheave,
wherein the first overspeed detection mechanism and the second overspeed detection mechanism are attached to the rotary body.

20. The governor for an elevator according to claim 12, further comprising a rotary body which is provided separately from the sheave and rotates with the sheave,
wherein the first overspeed detection mechanism and the second overspeed detection mechanism are attached to the rotary body.
